(19) United States
(12) Patent Application Publication
(10) Pub. No.: US 2009/0175424 A1
(43) Pub. Date: Jul. 9, 2009

(54) METHOD FOR PROVIDING SERVICE FOR USER

(75) Inventors: Bernt ANDRASSY, Munich (DE); Lutz Leutelt, Berlin (DE)

Correspondence Address: STAAS & HALSEY LLP, SUITE 700, 1201 NEW YORK AVENUE, N.W., WASHINGTON, DC, 20005, US

(73) Assignee: Siemens Aktiengesellschaft of Munich, Germany

(21) Appl. No.: 12/348,699

(22) Filed: Jan. 5, 2009

(30) Foreign Application Priority Data
Jan. 4, 2008 (EP) 08000118
Apr. 22, 2008 (EP) 08007787

(51) Int. Cl. H04M 1/64

(52) U.S. Cl. 379/88.02

(57) ABSTRACT

A voice-based classification method authenticates a user for a service which is reserved for a predetermined user group and is provided via a communication link in response to a request received from the user over a first communication link in an access control unit for access to the service. Over a second communication link a voice connection between the user and a speech processing unit is established. In the speech processing unit the voice of the user is recorded using a speech sample and at least a first criterion is checked, with the first criterion being fulfilled if the user is assigned to the predetermined user group. An age and or gender classification method may be used, with the predetermined user group being specified by its age and its gender. The service may be Internet-based, for example a chat room, in which persons of a specific age group interact.

### CROSS REFERENCE TO RELATED APPLICATIONS

This application is based on and hereby claims priority to European Application No. 08000118 filed on Jan. 4, 2008 and European Application No. 08007787 filed on Apr. 22, 2008, the contents of which are hereby incorporated by reference.

### BACKGROUND

Described below is a method for providing a service for a user as well as to a corresponding facility.

In a wide variety of applications it is necessary to protect specific user groups against intruders who use a service provided solely for the user group without being authorized to do so. Often these specific user groups are able to be characterized by parameters which can be derived from the voice of the users. In particular there are speech dialog systems known from the related art which can provide computer support to analyze the voice inputs of a user. For example the publication DE 20 2007 009 355 U1 discloses a speech dialog system with which the speaker can be classified in accordance with age and gender.

Nowadays, especially with Internet applications, there is a plurality of services which are only to be available to specific user groups. One example is so-called chat rooms, in which for example only young people communicate with each other. With such chat rooms it is especially important for the young people participating in the chat rooms to be protected against unauthorized intrusion by older people who wish to obtain information about young people without their permission.

For users to register for a protected service the service operators as a rule require evidence about the characteristics of the users, especially about their age and their gender. This is done for example by a user wishing to register for a service sending to a service operator a copy of a personal id card or providing their credit card details. In this case however it is problematic that the user under some circumstances has to reveal more data than is necessary for the use of the service. This opens up the possibility of misuse, especially through unauthorized data transfer to third parties or through credit card fraud. In addition younger users often do not posses corresponding documents for their personal identification or the data transferred for verification is not reliable and can be easily falsified.

### SUMMARY

An aspect is to create a method for providing a service for a user which makes it possible for the user, in a simple and secure manner, to authenticate themselves for participation in a service provided for a predetermined user group.

With the method a service is provided for a user, with the service only being intended for a predetermined user group and being provided over a communication link, especially over the Internet. In such cases the service can typically be a protected area of a web-based service, such as a chat room for example, that only persons of a specific age group can visit, in order to communicate and get to know each other.

First, a request from a user for access to the service is received in an access control unit via a first communication link which can correspond to the communication link over which the service is provided. The access control unit in this case is a corresponding server for example which is accessible via the Internet. Next, a voice connection between the user and a speech processing unit is established over a second communication link, which may possibly be the same communication link as the first, but can also differ from the latter. Then, the voice of the user is detected over the second communication link in the speech processing unit using a speech sample recorded by the user and subsequently at least one first criterion is checked. This first criterion is fulfilled if the user is assigned to predetermined user group, on the basis of a voice-based classification method. Finally, access to the service is facilitated for the user if at least the first criterion is fulfilled.

The method makes used of a voice-based classification method for providing the service, so that the user can be identified in a simple manner via a voice connection as to whether they fulfill the criteria of the predetermined user for which the provided service is intended. Classification methods known from the related art can be used as the voice-based classification method. For example the method disclosed in the above-mentioned publication DE 20 2007 009 355 U1 can be used as well as the method described in German Patent Application DE 10 2007 043 870.4.

In a variant of the method, access to the service is made possible for a user for whom the at least first criterion is fulfilled by the user being provided with authentication data over the first and/or second communication link for access to the service. This can be done for example by transferring a corresponding message in the form of an e-mail or SMS, however, in addition or as an alternative, the data can also be communicated to the user via a voice connection.

The voice-based classification method may be an age or gender classification method which classifies the age and or the gender of the user on the basis of the detected voice of the user. Such classification methods are sufficiently known from the related art, the reader being referred for example to the publication and patent application mentioned at the start. In such cases this type of age and/or gender classification method especially classifies the user into the male or female gender and/or into an age group from a plurality of age groups.

The user may be requested by the speech processing unit to speak a predetermined text as a speech sample and subsequently a second criterion will be checked, with the second criterion being fulfilled if the subsequently spoken text detected by a voice recognition method essentially matches the predetermined text, and with the user only being granted access to the service if at least the first and second criterion are fulfilled. In this way misuse is avoided by an unauthorized intruder who does not belong to the predetermined user group being able to use a recorded voice of a person with characteristics of the predetermined user group is order to gain access to the service. Such misuse is prevented in an especially effective manner by the predetermined text being created by a random generator and displayed to the user on a display unit or by being read out to the user over the existing voice connection. A text to be displayed on the display unit can in this case for example be transmitted over the second communication link or over any other communication link.

The method that defines a confidence value may be used as the voice-based classification method. This value specifies the probability with which a classification of a user into the predetermined user group is correct, whereby, in the event of the confidence value exceeding a first threshold value, the user is assigned to the predetermined user group. The first threshold value may be able to be set in such cases so that, depending on the application, a very high level of protection for the predetermined user group can be achieved by a high first threshold value or if necessary a correspondingly reduced level of protection can be achieved with a lower first threshold value. The disadvantage of setting a high threshold value is that users who actually belong to the user group are often rejected. However for user groups needing especial protection, such as young females for example, a very high level of protection is achieved. In cases in which the occasional intrusion of an unauthorized user is acceptable the first threshold value is set correspondingly lower.

The upper confidence value can also be used to make a further check on those users who were not able to be assigned to the predetermined user group with sufficient security. This is done by at least some of the users, who are assigned with a confidence value below a second threshold value lying above the first threshold value to the predetermined user group, being notified to a human operator over a user interface, with the human operator being able to listen-in over the user interface to the recorded voice of a user included in the at least one part of the users and being able to manually classify the users, with a third criterion for the user being fulfilled if the human operator classifies the user into the predetermined user group, and with the user only being able to access the service if the third criterion is fulfilled. Should the human operator, on listening in to the recorded voice of the respective user, not be able to make a unique classification, in an embodiment there is also the option of the human operator making contact with the user over a communication link, especially over a voice connection, in order to record further data for classification of the user, especially a further speech sample.

When human operators are included use is made of the knowledge that human operators in a few cases can better evaluate the voice of a user than is possible with a voice-based classification method, so that this checking with the human operator is undertaken for users with unclear assignment to a user group. The additional checking with the human operator can for example be undertaken on initial registration for the service, with in this case a user of the at least one part of the users only being provided with authentication data for access to the service if the third criterion is fulfilled. Likewise a check on a user can also be undertaken by a human operator after access to the service has already been provided. In this case the access to the service is blocked for a user if the third criterion for the user is not fulfilled.

Classification of users undertaken by the human operator with the assigned recorded voices is provided in a variant as training data for the voice-based classification method. In this way the classification method can be improved step-by-step.

In a further embodiment, the voice characteristic of the user is determined from the recorded voice of the user with a speaker recognition method. In this case a fourth criterion may be checked, with the fourth criterion being fulfilled if the change in the voice characteristic of the user within the speech sample is not greater than a predetermined level, with the user only being able to gain access to the service if the fourth criterion is fulfilled. In this way it is ensured that unauthorized users are detected who imitate a voice which slips during imitation in the speech sample. These users will be refused access to the service.

Likewise a fifth criterion can be checked with the fifth criterion being fulfilled for a user if his voice characteristic has a similarity to a voice characteristics of the users of a set of users which lies below a predetermined level, with the user only being able to gain access to the service if the fifth criterion is fulfilled. In this way an unauthorized intrusion by users is prevented who use the voice of one and the same person, with this person having a voice with which they are assigned to the predetermined user group.

To restrict the checking of the voice characteristics in a suitable manner, the set of users of which the voice characteristics are compared with each other can be restricted accordingly, for example via the telephone number and/or the locations of the user (where these can be determined) and/or the IP addresses of the users. This means that users with similar telephone numbers, locations or IP addresses are checked, since it can be assumed from this that users using the same voice for access to a service are cooperating with each other and are contacting the voice processing system with the same or similar telephone numbers or IP addresses.

Voice authentication for access to the service may be repeated after provision of the service for a user by the user being requested again to record his or her voice once more by the speech processing unit, with an already existing access to the service being blocked if the at least first criterion is not fulfilled.

For example, repeated voice authentication may use the current voice characteristic of the user, determined with the voice recognition method, compared with at least one voice characteristic of this user determined in previously, with the user's access to the service being blocked if the current voice characteristic deviates by a predetermined amount from the at least one voice characteristic determined previously. In this way for example unauthorized intruders who have initially gained access to the service by disguising their voice are recognized, with them no longer succeeding during a repeated check of the voice in disguising the voice in precisely the same way. Likewise intruders can be detected who, during an earlier authentication, have used the voice of a person of the predetermined user group, with this person no longer being prepared to lend the intruder their voice again in a renewed authentication.

Further, an identification assigned to the user may be detected during voice authentication, with the identifications of users already recorded being compared with the identification of the current user and in the case in which a user with the same identification as that of the current user was previously not allowed to access the service one or more times, the current user is not allowed to access the service regardless of the fulfillment of at least the first criterion. In this way repeated intrusion attempts by a user are avoided. The identification assigned to the user in this case for example includes the telephone number of the user and/or the location of the user (where known) and/or the IP address of the user and/or the location of the mobile radio cell in which the user is located.

The user can be offered an alternate authentication for access to the service if the at least first criterion is not fulfilled.

The user may be sent, in response to their service request, an address, especially a telephone number, that the user must contact to establish the voice connection. It is likewise possible for the user, in response to their request, to be contacted by the speech processing unit for establishing the voice connection.

The first or second communication link can be both a packet-switched and also a circuit-switched communication link. The first communication link may be an Internet connection between the user and the access control unit and the second communication link may be a circuit-switched telephone connection and/or a VoIP connection (VoIP=Voice-over-IP) between the user and the speech processing unit.

A classification distribution may be created from the classification undertaken with the voice-based classification method. Special variants of this creation of a classification distribution are set down in the specific description.

Also described below is a device for providing a service for a user, in which the device includes an access control unit as well as a speech processing unit which is embodied such that each variant of the method described above is thus able to be executed.

### BRIEF DESCRIPTION OF THE DRAWINGS

These and other aspects and advantages will become more apparent and more readily appreciated from the following description of the exemplary embodiments, taken in conjunction with the accompanying drawings of which:

FIG. 1 a schematic block diagram illustrating the execution sequence of an embodiment of the method;

FIG. 2 a schematic flowchart of a classification method that can be used in the method for providing a service;

FIG. 3 a schematic block diagram of a classification facility that can be used in the method for providing a service.

### DETAILED DESCRIPTION OF EXEMPLAR EMBODIMENTS

Reference will now be made in detail to the exemplary embodiments, examples of which are illustrated in the accompanying drawings, wherein like reference numerals refer to like elements throughout.

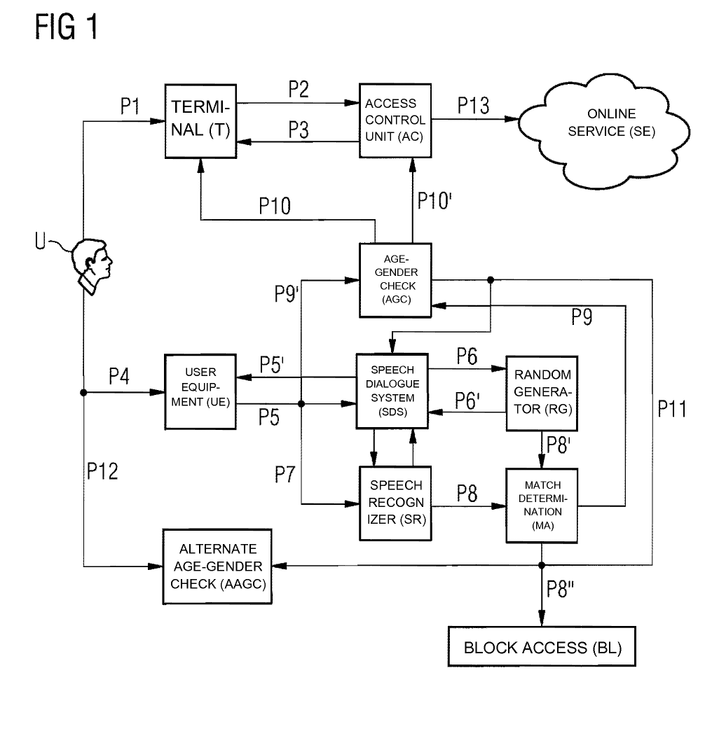

FIG. 1 shows a schematic diagram of the execution sequence of an embodiment of the method. According to FIG. 1 a user U wishes to obtain access to a service which is reserved solely for a specific age and gender group. An example of such an age-gender group is the target group of female persons aged between appr. 13 and 18 wishing to communicate and exchange information with each other. This user group is especially to be protected against unauthorized users, especially from adult males gaining unauthorized access to the service in order to make contact with the young women.

In the embodiment of FIG. 1 the user U first applies over the Internet, which represents a first communication link, for access to a protected online service for the closed user group of young women who are still minors. This is done by the user using a terminal T, which is especially a PC or a mobile device in the form of a laptop or a mobile to direct a request for access to the service via e-mail or by filling out a form in a browser to a corresponding access control unit AC. The process is indicated by the arrows P1 and P2 in FIG. 1. The access control unit AC involves a corresponding computer or server which controls access to the service, with the service being indicated in the diagram by the reference symbol SE in FIG. 1. As shown by the arrow P3, after the receipt of a corresponding request from a user U, a corresponding message is sent back in the access control unit AC to the terminal T. The message in this case can be an e-mail, an SMS and such like and contains a telephone number which the user can subsequently call to have the service SE enabled for them.

Subsequently the user U makes a call via corresponding user equipment UE, for example via a fixed-line telephone or a mobile telephone, to a speech processing unit which can communicate automatically via a central speech dialog system SDS with the user. A voice-based age-gender check on the user U is conducted with the aid of the speech processing unit. The arrow P4 indicates the process of the user U making the call via the user equipment UE. The speech dialog system SDS accepts the call, so that a voice connection can be established between the user U and the speech dialog system SDS, with this voice connection representing a second communication link. This can involve a circuit-switched or also a packet-switched voice connection via VoIP.

The speech dialog system SDS guides the user through the age-gender check, with voice entries made by the user indicated in the diagram by the arrow P5 and voice outputs from the speech dialog system SDS by the arrow P5′. Initially the speech dialog system SDS has a random generator RG to generate a random sequence of digits and letters, as indicated by the arrow P6. The randomly generated text sequence is returned in accordance with arrow P6′ to the speech dialog system. The text is subsequently read out automatically via the speech dialog system to the user or displayed by a corresponding display on the user equipment UE. It is explained beforehand to the user in this case that the spoken text is subsequently to be repeated by them. The user finally reads back the text, with the read-back text being recorded and fed to a speech recognizer SR (indicated by arrow P7).

The speech recognizer then makes a comparison between the required text generated by the random generator RG and the text spoken by the user. This comparison is shown in FIG. 1 by the block MA, with the actual text sequence detected by the speech recognizer SR being indicated by the arrow P8 and the actual generated required sequence which is compared to the sequence being generated by the arrow P8′. With the aid of the speech recognizer a check is thus made as to whether the user has really spoken the predetermined text sequence of the random generator RG. If they have not, the user is requested to repeat the text sequence once more. On a specific number of unsuccessful repetition attempts the user is rejected and where necessary the telephone number of the user will be blocked for a subsequent age-gender check, this being indicated in FIG. 1 by the block BL and the corresponding arrow P8″.

However, if the actual text sequence detected by the speech recognizer SR exhibits a sufficient match with the generated required text sequence, in accordance with arrow P9 the actual age-gender check is initiated which is indicated in FIG. 1 by the block AGC. The interposing of the speech recognizer SR especially helps to avoid misuse in which an unauthorized user communicates using a previously recorded voice with the speech dialog system SDS, with the recorded voice originating from a person who corresponds to the age-gender group, for which the service SE is reserved.

In the age-gender check AGC the speech sample of the user is now analyzed, with this speech sample corresponding to the text sequence previously spoken by the user. Where necessary it is also possible for a further speech sample to be included for the age-gender check. In FIG. 1 the supply of the speech sample to the age-gender check is represented by the arrow P9′. In the age-gender check the voice of the user is analyzed, with the age and the gender of the user being classified based on the analysis. In this case age-gender classification methods sufficiently known from the related art can be used, especially such methods as have already been described in the utility model DE 20 2007 009 355 U1 already mentioned at the start as well as in the German Patent Application DE 10 2007 043 870.4. The entire contents of the utility model publication and the patent application are made by reference to the content of the present application.

In the embodiment described here a specific variant of a statistical model for identification of the target user group of girls aged between 13 and 18 is used. For model generation of the accept model, in accordance with which a voice is assigned to the target user group, speech samples of girls and young women aged between 13 and 25 were used. The corresponding reject model, on the basis of which a voice is identified as not belonging to the target group, was implemented with male and female children up to 13 years of age, with male voices of any age as well as with male voices and children's voices attempting to imitate the voice of a young woman. In accordance with a model trained in this way it is now identified whether the user belongs to the target user group of female persons between 13 and 18 years of age. If the voice of the user U actually corresponds to the target user group, the user is correspondingly informed, for example by an e-mail, SMS and such like, which is indicated by the arrow P10. The e-mail or SMS is received in this case by the terminal T and contains the access data for the online service SE.

The access data can also be transmitted to the user via other communication paths, for example via a voice output by the speech dialog system SDS. In parallel to the transmission of the output data to the terminal T the access control unit is also informed about the output data (arrow P10′). It is likewise possible for the access data to be created on request by the speech processing unit by the access control unit and to be transmitted from this unit to the user. The access control unit can also be a component of an overall authentication system with speech processing unit and access control.

Should, in the voice-based age-gender check AGC, the voice not be able to be uniquely assigned to the protected target group of young women, the user is informed about this via the speech dialog system SDS and requested to undergo an alternate age-gender check AAGC (arrow P11′). The alternate age-gender check can, for example, rely in the user providing further data for authentication to the system, for example by transmitting a copy of their pass or ID card or providing the data of their credit card. This data is then checked by a further intensification body with, in the event of the data verifying that the user belongs to the target group of young women, this user likewise being allowed access to the service by the provision of corresponding access data. The provision of alternate data for the alternate age-gender check AAGC is shown in this case by the arrow P12 in FIG. 1.

In addition there is the option of dispensing with an alternate age-gender check, if the system establishes that the user has made a number of unsuccessful attempts to identify themselves via their voice. In such cases the user is identified for example by their telephone number via which they call the speech dialog system. After a predetermined number of unsuccessful attempts the telephone number is blocked for a further age-gender check, as again indicated by the arrow P8″ and the block BL. For final successful age-gender check either in accordance with AGC or alternatively using AAGC, the user can register using the access data provided to them with the protected online service and use this service (arrow P13).

With the embodiment of the method described above a voice-based age-gender check is used in a suitable manner for providing a service for predetermined target user groups. To improve protection again intruders who do not belong to the target user group, a speech recognizer has been additional employed which compares a randomly-generated text sequence with a speech sample of the user. This avoids speech samples recorded in advance with voices of persons belonging to the target user group being used for authentication for the protected service. Further measures are also conceivable with which the security of the system against attackers can be improved, with these measures being explained below.

On the one hand the statistical model, on which the age-gender check is based, can be set such that the model has a strong tendency to reject a voice which cannot be uniquely assigned to the target group, in order to keep the rate of accepted incorrect users very small. Should there still be unjustified incorrect rejections of users in such cases, these still have the possibility to identify themselves in another way using the alternate age-gender check AAGC.

In addition it is possible to optimize the quality of the authentication by an accompanying human interaction. In this case the confidences of accepted users determined by the age-gender check are taken into consideration. Such confidences are generally always determined by an age-gender check and they represent a measure of the probability which specifies how probable the user is to have been correctly assigned to the target user group. The accompanying human interaction can in this case be realized within the framework of an offline procedure. In such cases accepted users with low confidence, i.e. users, for which the age-gender check is unsure whether the user actually belongs to the target user group, can be checked by a human operator. This operator listens to the voice of the user and classifies this as to whether the user belongs to the target user group or not. The human operator can in this case in some cases classify the voice better than is possible with an automated age-gender classification method. Furthermore the human operator can establish contact with the user, for example through a call, in order to obtain further data for age-gender classification (“interview”). If the operator establishes that an intrusion is clearly occurring, the access already granted to the service for the accepted user and their account is blocked.

The recorded speech samples of intruders in combination with the classification of the human operator can further be included for improving the classification method, and this can be done by the reject model of the age-gender classification method being trained with these items. Instead of the offline procedure described above, in which the already accepted user with valid access data is checked again at a later time, the interaction with the human operator can also be undertaken as an online procedure. In such cases users with low confidences are checked close in time to the authentication process by a human operator, with access data only being issued if the operator comes to the conclusion that the user actually belongs to the target user group.

In a further embodiment of the method a speech recognizer can be used to increase the reliability of the age-gender check. A speech recognizer in such cases recognizes a voice characteristic of the speech sample provided by the user. In one embodiment the speech recognizer can compare the voice characteristics at the start and at the end of the speech sample with each other. Should it establish that the voice characteristic at the start and end differ greatly, it is possible that an attempt at intrusion is being made by the user modifying his voice in order to imitate a young woman's voice, but the voice modification has slipped while he is speaking.

There is also the possibility of the speech recognizer comparing with each other the voice characteristics of different users who have already communicated with the speech dialog system before. Should the speech recognizer establish that the voice characteristic of different users is very similar, there is again the possibility of an intrusion attempt, in which the voice of the same person has been used by a number of users to gain access to the service. To design the comparative checking of different users more effectively, especially only users with the same characteristics can be checked, with these same characteristics for example being specified by the telephone number or a part of the telephone number (e.g. the prefix) from which the user is calling, through the user location determined in another way or through the IP address that the user is using.

For further improving the protection of the service from unauthorized intrusion a user can also be requested to allow themselves to be subjected at regular intervals or at random intervals to a renewed age-gender check. In such cases a speech recognizer which records the voice characteristic of the user, checks whether this voice characteristic has changed markedly between age-gender checks lying at intervals from one another. In this way attempted intrusions can be detected for which the intruder has used a person from the target group in an earlier age-gender check to gain unauthorized access to the service, with this person from the target user group no longer being available in the renewed age-gender check and being replaced by another person. Furthermore attempts at intrusion are identified such as those in which a user has gained unauthorized access to a service by modifying their voice in an earlier age-gender check, with it no longer being possible for them to reproduce the imitated voice exactly in the repeated age-gender check.

The security against attempted intrusions into the protected services can be increased in a further embodiment by so-called “registered user signatures”. Registered user signatures are for example the telephone number via which the user contacts the speech processing system, the IP address via which the user is connected to the speech processing system when using VoIP, the location of the mobile radio cell in which the user is located if contact is established with the speech processing system via their mobile telephone. The registered user signature can in this case be used so that repeated unsuccessful intrusion attempts (e.g. three attempts) with the same registered user signature lead to this registered user signature being blocked. If a user with the same signature then makes contact with the voice recognition system again he is refused a renewed voice-based age-gender check. This is a way of ensuring that a user cannot attempt any number of times to obtain access to the service, by voice imitation for example.

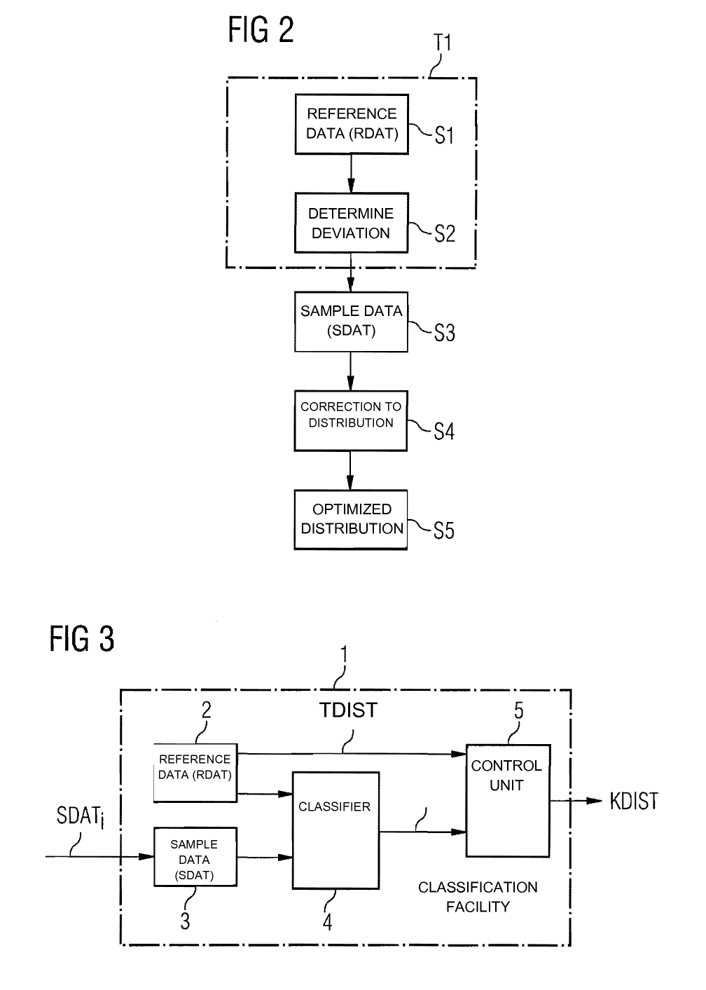

The age-gender check used in the method is undertaken with the aid of a corresponding classification method, with methods known from the related art being able to be used for this purpose. In particular in an embodiment with the classification method a classification distribution can also be created from which it can be seen how frequently different age-gender groups are attempting to gain access to the protected services. A specific embodiment of a classification method with optimized classification distribution is described below with reference to FIG. 2 and FIG. 3.

FIG. 2 shows the basic sequence of a variant of the method for classification of data described below. There is provision, in a training described with T1, for initially testing the characteristics of the classification method used. This includes the application of a classification method known per se to the reference data, as well as determining errors in the current classifications of the reference data and the assignment by the classification method.

Reference data RDAT can for example include commercially-obtainable databases with voice data of different speakers. In this case the respective characteristics of the speakers who have created the respective expressions or voice recordings are known. In the previous application the desire is to arrange the calls received or callers into classes which depend on the age and the gender of the caller. Examples of such classifications include a classification into a first child class CH for callers with an age of for example less than 14 years. A second class YM can include young males aged between 14 and 20 years. A third group could feature corresponding young female adults YF. Adult males AM between the ages of 20 and 65 are recorded as the fourth group or class and similar adult females AF as the fifth group. In addition a sixth group can include senior males SM aged over 65 and a seventh group corresponding senior females SF.

For the reference data RDAT to be classified in the training T1 the respective classifications are known. In S1 the classification is thus undertaken with the aid of the classification method or a corresponding classifier which can for example be a computer program. This produces a classification distribution DIST, which in the ideal case matches the true distribution TDIST.

In S2 the deviation, for example the difference between the relative proportion of the current assignment and the relative proportion of the assignment of the reference data undertaken by the classification method is determined. Overall a measure for the classification accuracy or the classification error CE can be computed which essentially corresponds to half the total of the respective deviation in the percentage proportions. This is explained in greater detail below.

In S3 available data samples, such as for example callers or recorded voice data of a respective caller are classified by the known classification method. The data to be classified is designated SDAT and include a predetermined number of data samples. A data sample corresponds in this case for example to a call. As a result a classification distribution is thus designated DIST. Since the classification method inevitably cannot assign all data samples correctly, a correction of this (provisional) classification distribution DIST is undertaken in S4.

The error which is triggered by the classification method also depends in this case on the distribution or the respective callers. For example the case can occur of systematic data samples corresponding to adult males AM being swapped with data samples which correspond to young males YM. Knowing this tendency of the classification method to confuse these two classes AM, YM with each other or to undertake an incorrect assignment of AM to YM, a correction of the distribution obtained can now be undertaken. As a result the method then delivers in S5 an optimized distribution KDIST which corresponds more closely to the actual distribution.

The method shown in FIG. 2 can for example be executed in a classification facility as shown in FIG. 3. To this end FIG. 2 shows a block diagram of a facility which for example can run as a computer implementation on a PC.

The facility for classifying data in this case especially has a control unit 5, which undertakes the evaluation and correction of distributions DIST generated by a classifier 4. The facility 1 is equipped with an optional memory 2 for reference data RDAT and features a classification data memory 3 for buffering the data to be stored SDAT. For example data samples SDATi can be copied to the classification facility 1 and buffered in the classification memory 3. The control unit 5 in this case for example coordinates the execution of the method indicated schematically in FIG. 2.

This means that initially the reference data RDAT is classified by the classifier 4, through which the classification or control unit 5 creates a distribution. This can be compared with the true distribution TDIST in the knowledge of the reference data stored in the reference data memory 2. Finally the classifier unit 4 also creates a distribution DIST from the data SDAT to be classified. By applying the corrections in accordance with a method described below in greater details using examples a corrected or optimized distribution KDIST is produced. Furthermore if a typical methodology for calculating the corrected distribution KDIST will be explained below.

The errors of the classifier or of the classification method used are essentially reflected in confusions between the classes. These confusions between correct and incorrectly assigned data samples to the predetermined classes are sufficiently similar on sufficiently large numbers of callers. These errors can be understood as a linear mapping from the actual distribution to the observed distribution. A measure CE for a classification error can for example be as follows:

$$CE = {\sum }_{Classes} \vert actual proportion - assigned proportion \vert / 2$$

This image can be determined by a training quantity or reference data samples, with known class classifications, and be inverted for the correction of the inherently error-prone error classification distribution DIST.

Mathematically this methodology can be described as follows. Ω is entered as the set of all possible calls or data samples or reference data samples. The mapping X: n Ω→{1, . . . , n} is the random variable of the actual classification, with n classes being assumed. In the typical case of caller classification n=7, namely CH, YM, YF, AM, AF, SM, SF is provided. Y: Ω→{1, . . . , n} represents the random variable which corresponds to the classification results from the classification method. For an ideal classifier X=Y then applies.

Let A⊂Ω now be a finite subset of calls which will be investigated. X′:A>{1, . . . , n} and Y′:A>{1, . . . , n} are then restrictions of X and Y to A. Thus X′ are the classes to which the callers belong, i.e. the reference distribution or class memberships of the reference data samples, and Y′ are the classification results which will be delivered by a predetermined method.

The distributions of the class memberships p(X′=i) are now sought, with the distribution of the classification results p(Y′=i) being known. It is assumed that on sufficiently large sets of users the confusions between classes are as a rule the same, i.e. constants c_{i,j} exist, so that for almost all A the following approximation applies:

p(Y′=i|X′=j)≈c_{i,j}.

The c_{i,j} can for example be understood as the matrix representation of a linear image. From a predetermined number of known reference data samples with known X′ the c_{i,j} can be estimated from the relative frequencies for the classes. This inversion problem can be resolved by an equation system using conditional probability:

$$p ( {Y}^{′} = j ) = {\sum }_{i = 1 … n} p ( {Y}^{′} = j , {X}^{′} = i ) = {\sum }_{i = 1 … n} p ( {Y}^{′} = j \vert {X}^{′} = i ) \cdot p ( {X}^{′} = i ) = {\sum }_{i = 1 … n} {c}_{i , j} p ( {X}^{′} = i ) .$$

Thus a correction image c_{i,j} is obtained, by which the classification distribution DIST can be optimized in order to obtain a reliable distribution into classes.

The c_{i,j} can thus be defined with known class memberships, in that the relative frequencies or proportions of the respective incorrect assignments are counted by the classification method. Subsequently the matrix of the c_{i,j} produced is inverted. For determination of the class distributions p(X′=i) the corresponding vector of the average classification results p(Y′=i) is multiplied by this inverse matrix for correcting the (suboptimal) distribution obtained. In principle values can also arise through this multiplication which are greater than 100% and less than 0%. These are truncated for example, and subsequently the result is normalized to 100%.

A further variant of the method for classifying data or for correction of classification distributions obtained through a known classification method is explained below. Essentially this variant is based on the mathematical description as previously.

A few classifiers, as well as the most probable class membership of a data sample also supply a confidence which describes how certain the classifier is for the assignment result. It is assumed that the smaller the confidence value is on average, the more likely assignment errors are to have occurred.

The confidence or assignment certainty is described as a further random variable F: Ω→R^{m}, which assigns to each call or data or reference data sample a two-dimensional feature vector. Thus not only the p(Y′=i), but also all so-called a-posteriori probabilities or confidences p(X=i|F=f) are known for a given feature vector f. As before, what is being looked for is the permutation matrix p(Y′=i|X′=j), which is now computed for each A.

The probability of confusion can be assumed to be precisely as great as the a-posteriori probability of an incorrect classification result. Thus for a sufficiently large value of A it is true that the confusion distribution on A is roughly as large as the average a-posteriori probability that the classifier will assign incorrect results. This can be clearly expressed as:

p(Y′=j|X′=i)≈p(X=j|F=f_{X′,i}),

with f_{X′,I} being those feature vectors to which the callers or data samples from the class i are assigned. Since the classification X′ is a-priori not known, but only the classification results Y′ are available, only the p(X=j|F=f_{Y′,i}) are known. One can however make assumptions about the distribution of the a-posteriori probabilities, so that the p(X=j|F=f_{X′,i}) can be estimated.

This will be illustrated using a typical 2-class assignment problem with symmetrical confusions. It can then be shown for example, that for i≠j:

p(Y′=j|X′=i)≈0.5[p(X=1|F=f_{Y′,2})+p(X=2|F=f_{Y′,1})]

and for i=j:

p(Y′=i|X′=i)≈0.5[p(X=1|F=f_{Y′,1})+p(X=2|F=f_{Y′,2})]

the following applies. This estimation for c_{i,j} likewise delivers further improved corrections for the distributions to the classes into the respective classification distribution.

Although the present invention has been explained in greater detail with reference to exemplary embodiments, it is not restricted to the embodiments but is able to be modified in diverse ways. In particular the user can be given a free hand in the choice of the underlying classification method. The classes given in the age-gender groups are likewise only to be understood as examples. The classification of data or data samples described above can be usefully employed whenever reference or training data is able to be obtained and deviations from correct assignments are able to be determined by the classification method.

The system also includes permanent or removable storage, such as magnetic and optical discs, RAM, ROM, etc. on which the process and data structures of the present invention can be stored and distributed. The processes can also be distributed via, for example, downloading over a network such as the Internet. The system can output the results to a display device, printer, readily accessible memory or another computer on a network.

A description has been provided with particular reference to exemplary embodiments thereof and examples, but it will be understood that variations and modifications can be effected within the spirit and scope of the claims which may include the phrase “at least one of A, B and C” as an alternative expression that means one or more of A, B and C may be used, contrary to the holding in Superguide v. DIRECTV, 358 F3d 870, 69 USPQ2d 1865 (Fed. Cir. 2004).

What is claimed is:

1. A method for providing a service for a predetermined user group via a communication link, comprising:
receiving a request from a user over a first communication link in an access control unit for access to the service;
establishing a voice connection via a second communication link between the user and a speech processing unit;
checking voice signals produced by the user, captured in the speech processing unit after receipt via the second communication link of a speech sample, for at least one first criterion, with the first criterion being fulfilled if the user is assigned to the predetermined user group, according to a voice-based classification method;
enabling access to the service by the user when at least the first criterion is fulfilled.

2. The method as claimed in claim 1, wherein said enabling includes providing the user, via the first and/or second communication link, with authentication data for access to the service by authentication at the access control unit.

3. The method as claimed in claim 2, wherein the voice-based classification method is an age and/or gender classification method which, based on the voice signals of the user, classifies the age and/or the gender of the user.

4. The method as claimed in claim 3, wherein the age and/or gender classification method classifies the user by male or female gender and/or into an age group from a plurality of age groups.

5. The method as claimed in claim 4,
further comprising:
requesting the user by the speech processing unit to repeat a predetermined text as a speech sample; and
checking a second criterion, with the second criterion being fulfilled if text as spoken by the use is recognized by a speech recognition method as essentially matching the predetermined text, and
wherein said enabling allows the user to access the service only if at least the first criterion and the second criterion are fulfilled.

6. The method as claimed in claim 5, further comprising:
creating the predetermined text by a random generator; and
providing the predetermined text to the user on a display unit and/or over the voice connection.

7. The method as claimed in claim 6, wherein the voice-based classification method defines a confidence value which specifies a probability with which a classification of the user into the predetermined user group is correct, and when the confidence value exceeds a first threshold value, the user is identified as a member of the predetermined user group.

8. The method as claimed in claim 7, further comprising setting the first threshold value.

9. The method as claimed in claim 8,
further comprising:
notifying a human operator via a user interface for at least some of the users who are assigned the confidence value below a second threshold value and above the first threshold value;
having the human operator listen in via the user interface to the voice signals of the user when in the at least one part of the users; and
manually classifying the user with a third criterion being fulfilled for the user if the human operator classifies the user in the predetermined user group, and
wherein said enabling makes possible for the user to access the service only if the third criterion is fulfilled.

10. The method as claimed in claim 9, further comprising:
contacting the user by the human operator over the voice connection; and
recording from the user data for the classification of the user in a further speech sample.

11. The method as claimed in claim 10, further comprising providing the user, when in the at least one part of the users, with authentication data for access to the service if the third criterion is fulfilled for the user.

12. The method as claimed in claim 11, further comprising blocking access already provided for the user, when in the at least one part of the users, if the third criterion is not fulfilled for the user.

13. The method as claimed in claim 12, further comprising providing a manual classification of a portion of the users by the human operator with recorded voices as training data to the voice-based classification method.

14. The method as claimed in claim 13, further comprising determining a voice characteristic of the user from the voice signals of the user using a speaker recognition method.

15. The method as claimed in claim 14,
wherein said checking of the voice signals includes checking a fourth criterion that is fulfilled for a user if a change in the voice characteristic of the user within the speech sample is not greater than a predetermined amount, and
wherein said enabling only makes possible for the user to access the service if the fourth criterion is fulfilled.

16. The method as claimed in claim 15,
wherein said checking of the voice signals includes checking a fifth criterion that is fulfilled for a user if the voice characteristic of the user has a similarity to voice characteristics of selected users in a user set which lies below a predetermined level, and
wherein said enabling only makes possible for the user to access the service if the fifth criterion is fulfilled.

17. The method as claimed in claim 16, wherein the user set is specified by telephone number and/or location and/or IP address of each of the selected users.

18. The method as claimed in claim 17, further comprising repeating said checking of the voice signals and said enabling after initial provision of the services for the user, in that the user is requested again by the speech processing unit to record current voice signals and an already existing access to the service being blocked if the at least first criterion is not fulfilled by the current voice signals.

19. The method as claimed in claim 18,
wherein said checking of the voice signals of the user includes
determining a current voice characteristic of the user using the speaker recognition method; and
comparing the current voice characteristic of the user with at least one previous voice characteristic of the user determined in a previous iteration of said checking of the voice signals, and
wherein said enabling blocks access to the service by the user if the current voice characteristic deviates by more than a predetermined amount from the at least one voice characteristic.

20. The method as claimed in claim 19,
wherein said checking of the voice signals of the user includes
recording an identification assigned to the user; and
comparing identifications of the users already recorded with the identification of the user, and
wherein said enabling blocks access to the service when the identification of the user is associated with at least one previous denial of access to the service regardless of whether the first criterion is fulfilled.

21. The method as claimed in claim 20, wherein the identification assigned to the user includes the telephone number of the user and/or the location of the user and/or the IP address of the user and/or a mobile radio cell location in which the user is located.

22. The method as claimed in claim 21, further comprising offering the user an alternate authentication for access to the service if the at least first criterion is not fulfilled.

23. The method as claimed in claim 22, further comprising sending to the user, in response to the request received from the user, a telephone number which the user must contact to establish the voice connection.

24. The method as claimed in claim 23, wherein said sending is performed by the speech processing unit to establish the voice connection.

25. The method as claimed in claim 24, wherein the first and/or the second communication link are a packet-switched and/or circuit-switched communication link.

26. The method as claimed in claim 25, wherein the first communication link is an Internet connection between the user and the access control unit.

27. The method as claimed in claim 26, wherein the second communication link is a circuit-switched telephone connection and/or a VoIP connection between the user and the speech processing unit.

28. The method as claimed in claim 13, further comprising creating a classification distribution from the classification using the voice-based classification method.

29. A facility for providing a service for a user, with the service being intended for a predetermined user group and provided via a communication link, comprising:
an access control unit receiving, via a communication link during operation of the facility, a request by the user for access to the service;
a speech processing unit establishing, during operation of the facility, a voice connection via a second communication link between the user and the speech processing unit, recording a voice of the user obtained via the second communication link in a speech sample, and checking at least a first criterion, with the first criterion being fulfilled if the user is assigned to the predetermined user group, in which case said access control unit makes possible for the user to access the service.

30. The facility as claimed in claim 29, which is embodied such that the method as claimed in claim 2 is able to be executed by the facility.
